(19) United States
(12) Patent Application Publication
(10) Pub. No.: US 2009/0104312 A1
(43) Pub. Date: Apr. 23, 2009

(54) NEUTRALIZED JUICE-BASED BEVERAGES AND METHOD OF MAKING SAME

(76) Inventors: A. Reza Kamarei, Apopka, FL (US); Timothy A. Anglea, Windermere, FL (US); Young Chan Kang, Alpharetta, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/953,394

(22) Filed: Dec. 10, 2007

Related U.S. Application Data
(60) Provisional application No. 60/981,601, filed on Oct. 22, 2007.

(51) Int. Cl. A23L 2/02; A23L 1/30; A23L 1/302; A23L 1/305; A23L 1/304; A23C 9/133

(52) U.S. Cl. 426/72; 426/599; 426/580

(57) ABSTRACT

The present disclosure is directed to a neutralized juice base comprising at least one acidic juice neutralized with at least one alkaline additive, wherein the neutralized juice base has a pH ranging from about 5.0 to about 6.1. The present disclosure is also directed to a beverage composition comprising at least one neutralized juice base and at least one beverage component, wherein the beverage composition is a low-acid composition. The present disclosure is further directed to methods of making the neutralized juice base and methods of making the beverage compositions.

This application claims the benefit of U.S. Provisional Application No. 60/981,601, filed Oct. 22, 2007, which is incorporated by reference herein in its entirety for any purpose.

The present disclosure is directed to neutralized juice bases comprising at least one juice neutralized with at least one alkaline additive, wherein the neutralized juice base has a pH ranging from about 5.0 to about 6.1. This disclosure also relates to beverage compositions comprising at least one neutralized juice base and at least one beverage component, wherein the beverage composition is a low acid composition.

Juices, such as orange juice, apple juice, and other fruit juices, are generally acidic (i.e. they generally have a pH equal to or less than 4.5). Although juices contain carbohydrates and some vitamins and minerals, juices generally do not contain, or minimally contain, proteins or lipids, and many vitamins and minerals are lacking. Such nutrients allow for maintenance of a healthy, balanced diet. However, it is usually difficult to add such nutrients (e.g., proteins) directly to juices as the acidic pH of juices causes nutrients such as proteins to coagulate and/or precipitate, which can result in undesirable sensory characteristics and/or reduce the storage stability of the beverage.

It is further difficult to combine acidic juices with other less acidic or neutral beverage components containing some of those nutrients, such as milk (dairy milk) or soy milk. Again, this may be, in part, due to the low pH of juices.

Previous attempts to formulate juice-based beverages with added protein and/or non-acidic beverage components generally revolved around altering some component of the beverage. In many of those instances, either the nutrient components, or both the juice and the nutrient components, were manipulated or stabilized with additives to produce a stable, organoleptically acceptable product.

In some formulations, the beverages require stabilizers. U.S. Pat. No. 3,692,532 discloses a milk-fruit juice beverage wherein carboxymethylcellulose is used to stabilize the beverage. U.S. Pat. No. 5,286,511 discloses a method of suspending soy protein particles in an acidic beverage by dissolving pectin or pectic compounds in the acidic beverage prior to adding the protein. U.S. Pat. No. 6,811,804 discloses a fruit juice/puree and soy protein beverage wherein pectins are preferably used to enhance physical stability and control viscosity of the beverage. U.S. Pat. No. 6,171,633 discloses a milk-based drink comprising milk, juice, a gum-based stabilizer, and a component comprising an amino acid, an organic acid or inorganic acid, and a metal ion.

In other examples, the beverage components are processed in order to produce a stable, juice-based beverage. U.S. Pat. No. 4,676,988 discloses a method of preparing low-acid juice-milk beverages by first decationizing milk with a cation exchange resin to a pH below 3.2 to 1.5, and then anion exchanging the milk to a pH of 3.5 to 4.5. A juice component is prepared by decationizing the juice to a pH of 2.5 to 1.3, deanionizing the juice to a pH of 8 to 11.3, then acidulating the juice by cation exchange to a pH of 3.0 to 4.5. The juice and milk components are then blended together. U.S. Pat. No. 5,260,085 discloses a shelf-stable milk-containing beverage product containing water, milk solids, a two component stabilizing system (of monoglycerides and up to 10% by weight of diglycerides, plus pectin or carrageenin or both) to stabilize the emulsion in the beverage product produced from the milk, and an aqueous flavoring system comprising an acidic flavoring agent combined with a buffering system. The buffering system comprises disodium phosphate and potassium bicarbonate, which can be thermally decomposed to potassium hydroxide and carbon dioxide in the beverage product.

There is a need for stable, juice-based compositions which can be readily combined with other beverage components without affecting the sensory or organoleptic qualities of the beverage components.

The present disclosure relates to neutralized juice bases comprising at least one juice and at least one alkaline additive, the juice bases having a pH ranging from about 5.0 to about 6.1. The disclosure also relates to methods of making the neutralized juice bases comprising combining at least one juice with a sufficient amount of at least one alkaline additive to form a neutralized juice base having a pH ranging from about 5.0 to about 6.1.

The present disclosure further relates to beverage compositions in which neutralized juice bases can be combined with other beverage components. In one embodiment, the present disclosure is directed to a beverage composition comprising: at least one neutralized juice base comprising at least one acidic juice neutralized with at least one alkaline additive, wherein the at least one neutralized juice base has a pH ranging from about 5.0 to about 6.1; and at least one beverage component, wherein the beverage composition is a stabilizer free, low-acid composition.

The disclosure also relates to a process for making a beverage composition comprising neutralizing at least one acidic juice with at least one alkaline additive to form at least one neutralized juice base having a pH ranging from about 5.0 to about 6.1; and combining the at least one neutralized juice base with at least one beverage component to form a stabilizer free, low-acid beverage composition.

Additional aspects of the disclosure will be set forth in part in the description that follows. It is to be understood that both the foregoing general description and the following detailed description are exemplary and explanatory only and are not restrictive of the disclosure, as claimed.

In one embodiment, the present disclosure is directed to a neutralized juice base comprising at least one juice neutralized with at least one alkaline additive, wherein the juice base has a pH ranging from about 5.0 to about 6.1. In some embodiments, the juice base has a pH ranging from about 5.5 to about 6.0. In further embodiments, the present disclosure is directed to a beverage composition comprising: at least one neutralized juice base and at least one beverage component, wherein the beverage composition is a low-acid or non-acidic composition.

The beverage compositions of the present disclosure comprise at least one neutralized juice base and at least one beverage component, such as a ready-to-drink beverage component. Accordingly, the beverage compositions can be ready-to-drink beverage compositions, e.g. single strength beverage compositions. Alternatively, beverage compositions of the present disclosure can also be used as a drink base, e.g., as a concentrated drink base, for combination with additional beverage components, and/or water, and/or nutrient additives, and/or optional ingredients. In this case, the resulting beverage compositions are also stabilizer free, low-acid beverage compositions-to minimize coagulation or precipitation of any beverage components, and/or any nutrient additives, and/or any optional ingredients.

As used herein, the term “neutralized” refers to alteration of the pH of an acidic juice such that the pH is no longer acidic (e.g., the pH ranges from about 5.0 and up) but still retains acceptable sensory characteristics. The neutralized pH of the juice base allows the juice base to be combined with at least one beverage component with minimal coagulation or precipitation. Thus, beverage components that normally are not readily combinable with juice, due to the adverse effects of acidic juice on the sensory qualities of the beverage components, may be combined with the neutralized juice base of the disclosure to produce desirable beverage compositions with minimal processing. The beverage compositions of the disclosure have desirable organoleptic and/or sensory qualities and are stable under prolonged storage conditions.

As used herein, the terms “beverage,” “beverage component,” and “beverage composition” each refer to a liquid that is appropriate for human or animal consumption.

### Alkaline Additives

At least one alkaline additive is used to neutralize an acidic juice to form the neutralized juice base of the present disclosure. The alkaline additives are not used as buffering agents or as part of multi-component buffering systems. Such alkaline additives comprise food grade alkali or food grade alkalizing salts, including, but not limited to, at least one alkaline additive chosen from calcium hydroxide, potassium hydroxide, sodium hydroxide, magnesium hydroxide, bicarbonate, carbonate and citrate salts of such food grade alkali, and mixtures thereof. For example, the alkaline additives can comprise calcium hydroxide, potassium hydroxide, potassium carbonate, sodium citrate, potassium bicarbonate, or sodium bicarbonate. The alkaline additives can be chosen for organoleptic compatibility with the juice in the neutralized juice base.

### Juice

The at least one juice in the neutralized juice base of the beverage composition comprises at least one acidic juice. For example, the at least one acidic juice is chosen from at least one acidic fruit juice, at least one acidic vegetable juice, and acidic mixtures of fruit and vegetable juices.

In one embodiment, the at least one acidic juice comprises at least one acidic fruit juice or an acidic blend of fruit juices. The fruit juice can be chosen from, but is not limited to, orange juice, apple juice, grape juice, pear juice, cranberry juice, raspberry juice, strawberry juice, blueberry juice, blackberry juice, gooseberry juice, elderberry juice, cherry juice, currant juice, pineapple juice, lemon juice, lime juice, grapefruit juice, quince juice, plum juice, prickly pear juice, tangelo juice, pomelo juice, calamondin juice, mango juice, banana juice, kiwi juice, peach juice, nectarine juice, apricot juice, tangerine juice, clementine juice, minneolas juice, satsuma juice, mandarin orange juice, kumquat juice, pomegranate juice, watermelon juice, honeydew melon juice, cantaloupe melon juice, guava juice, papaya juice, passion fruit juice, star fruit juice, tamarind juice, cupuaca juice, and/or mixtures thereof. Further for example, the fruit juice is chosen from orange juice, apple juice, grape juice, and mixtures thereof.

In addition, when white grape juice is neutralized with an alkaline additive, the resulting neutralized white grape juice base of the present disclosure is a relatively neutral-flavored juice base, which does not have a strong fruit flavor. Accordingly, neutralized white grape juice base, either in concentrated form or at single strength, can be useful as a sweetener that does not contribute a strong fruit flavor to beverage compositions of this disclosure. It is particularly useful where it is desirable that a beverage composition contain no added sugar or minimally added sugar. For example, neutralized white grape juice base can be combined with milk (or soymilk) and chocolate or other flavoring to produce a naturally sweetened chocolate milk beverage or chocolate soymilk beverage.

The at least one acidic juice may also comprise an acidic vegetable juice, (e.g., tomato juice), or an acidic blend of vegetable juices (e.g., a blend of tomato, carrot, and celery juice, etc.). Mention may be made among vegetable juices including, but not limited to, juice from tomatoes, carrots, spinach, peppers, cabbage, sprouts, broccoli, potatoes, celery, anise (fennel), cucumbers, parsley, cilantro, beets, wheat grass, asparagus, zucchini, squash, rhubarb, turnips, rutabagas, parsnips, radishes, watercress, endive, escarole, lettuce, spinach, garlic, onion, ginger, and/or mixtures thereof.

The at least one acidic juice of the neutralized juice base of the present disclosure can comprise a full strength juice as provided in 21 C.F.R. Part 101.30 or a non-full strength juice drink. The full strength juice can be prepared from a concentrate or it can be not-from-concentrate. The at least one acidic juice of the neutralized juice base may also be a juice concentrate.

The at least one neutralized juice base is present in the beverage composition in an amount equivalent to about 20% to about 80% by volume of the beverage composition as a single strength juice base. If the neutralized juice base comprises a juice concentrate (for example, a 2-times concentrated juice base), the neutralized juice base can be present in an amount that would be equivalent to about 20% to about 80% by volume of a single strength juice base. In some examples, the at least one juice base is present at, or is present in amount equivalent to, about 20%, 25%, 30%, 35%, 40%, 45%, 50%, 55%, 60%, 65%, 70%, 75%, or 80% by volume of the beverage composition as a single strength juice base. When the beverage composition comprises two or more juice bases, the juice bases together comprise, or are equivalent to, about 20% to about 80% by volume of the beverage composition as single strength juice bases.

### Beverage Component

The at least one beverage component of the beverage composition of the disclosure may comprise any beverage component that can be mixed with at least one neutralized juice base. For example, the at least one beverage component can be chosen from, but is not limited to, dairy milk, soy milk, rice milk, coconut milk, botanical extracts, teas, coffees, protein drinks, protein emulsions, meal replacement drinks, sports drinks, energy drinks, soft drinks, carbonated drinks, frozen carbonated beverages, frozen uncarbonated beverages, functional drinks (i.e. nutraceuticals or drinks containing functional additives or components), health drinks, nectars, smoothies, shakes, tonics, horchata (i.e., vegetable and/or rice components made into a beverage), syrups, cordials, dilutable drinks, and mixtures thereof. The at least one beverage component may comprise a single strength beverage component (for example, fresh milk) or it may comprise a concentrated beverage component (for example, concentrated milk prepared from a milk powder, or evaporated milk).

The at least one beverage component in the beverage composition of the present disclosure may be present in an amount equivalent to about 80% to about 20% by volume of the beverage composition, as a single strength beverage component. If the beverage component is a concentrated component (for example, concentrated milk), the beverage component can be present in an amount equivalent to about 80% to about 20% by volume of a single strength beverage component. In some examples, the at least one beverage component is present at, or is present in amount equivalent to, about 80%, 75%, 70%, 65%, 60%, 55%, 50%, 45%, 40%, 35%, 30%, 25%, or 20% by volume of the beverage composition, as a single strength beverage component. When the beverage composition comprises two or more beverage components, the beverage components together comprise, or are equivalent to, about 80% to about 20% by volume of the beverage composition as single strength beverage components.

The at least one beverage component has a pH which, when combined with the at least one neutralized juice base, can result in a low-acid beverage composition. For example, when one beverage component is combined with at least one neutralized juice base, the resulting beverage composition can be a low-acid beverage composition. In some embodiments, the at least one beverage component can have a pH ranging from about 5.0 to about 8.0, which allows it to be combined with at least one neutralized juice base with minimal coagulation or precipitation. Further for example, when a beverage composition comprises two or more beverage components, the combined pH of the beverage components with at least one neutralized juice base can also result in a low-acid beverage composition.

In one embodiment of the present disclosure, the at least one beverage component comprises dairy milk, soy milk, or mixtures thereof. The dairy milk or soy milk may be pasteurized or unpasteurized. The dairy milk may contain lactose, be lactose-reduced, or be lactose-free. The dairy milk may also comprise whole milk (containing greater than 3% butterfat by weight), reduced fat milk (containing 2% butterfat), low fat milk (containing 1% butterfat), or skim milk (containing virtually no butterfat). The dairy milk or soy milk may also be flavored milks, such as, for example, chocolate, strawberry, vanilla, coffee, caramel, or other flavored milks.

Botanical extracts can be used as beverage components and are often obtained from, for example, but not limited to, beans, nuts, bark, leaves and roots of a plant. For example, botanical extracts may include, but are not limited to, juices and extracts from guarana, ginger, ginseng, ginkgo, aloe vera, herbs, including mint, spices, including cinnamon, vanilla beans, cocoa beans, nuts, and mixtures thereof.

The beverage component of the present disclosure may also comprise functional drinks (also known as nutraceuticals or drinks containing functional additives or components) or health drinks. Such functional drinks or health drinks include at least one component that may provide health benefits beyond basic nutrition.

### Water

The beverage composition of the present disclosure may further comprise water. The water may be “treated water”, “purified water”, “demineralized water”, and/or “distilled water.” The water should be suitable for human consumption and the beverage composition should not be, or should not be substantially detrimentally, affected by the inclusion of the water. This added water to the beverage composition is in addition to water found in or with other components of the present disclosure, e.g., the at least one juice of the at least one juice base or the at least one beverage component. For example, water may be added to dilute at least one juice base and at least one beverage component to create a single strength, ready-to-drink beverage composition. The added water component may also meet certain quality standards such as biological, chemical, nutrient, and sediment criteria.

The water hardness of the added water component may range from about 55 ppm to about 250 ppm, such as from about 60 ppm to about 180 ppm. Water hardness refers to the amount of cations, e.g., calcium carbonate, present in the water. As provided in the present disclosure, water hardness is measured according to the Association of Official Analytical Chemists (AOAC) standards described in the Official Methods of Analysis, published by the AOAC (William Horwitz ed., 18th ed. 2005), the relevant contents of which are incorporated herein by reference.

### Nutrient Additives

The beverage composition of the disclosure may further comprise at least one nutrient additive suitable for inclusion in the beverage composition. For example, due to the neutralized pH of the beverage composition, the beverage composition of the present disclosure allows nutrient additives to be combined with the at least one juice base and at least one beverage component with minimal coagulation or precipitation of the additives. The beverage composition of the present disclosure can be useful for the addition of nutrient additives which are normally adversely affected by the acidic pH of juice. The nutrient additives may be chosen from, but not limited to, proteins, amino acids, carnitine, taurine, ribose, inositol, vitamins, minerals, antioxidants, caffeine, carbohydrates, lipids, functional additives, and mixtures thereof.

### Proteins

The beverage compositions of the present disclosure may further comprise at least one protein component. The at least one protein component may be chosen from, for example, but is not limited to, soy protein, milk proteins such as casein (caseinate), whey protein, egg whites, gelatin, collagen, and mixtures thereof. The pH of the at least one juice base and the at least one beverage component can allow for proteins to be added to the beverage composition.

### Amino Acids

According to the present disclosure, the beverage compositions may further comprise at least one amino acid. The at least one amino acid may be naturally or synthetically derived. The at least one amino acid may be chosen from, but is not limited to, alanine, arginine, aspartate, asparagine, cysteine, glutamate, glutamine, glycine, histidine, isoleucine, leucine, lysine, methionine, ornithine, proline, phenylalanine, serine, threonine, tryptophan, tyrosine, valine and mixtures thereof.

### Vitamins and Minerals

According to the present disclosure, at least one supplemental vitamin and/or mineral may be optionally incorporated into the beverage compositions of the present disclosure. Mention may be made among vitamins such as, but not limited to, riboflavin, niacin, pantothenic acid, pyridoxine, cobalamins, choline bitartate, niacinamide, thiamin, folic acid, d-calcium pantothenate, biotin, vitamin A, vitamin C, one or more B-complex vitamins such as vitamin B1 hydrochloride, vitamin B2, vitamin B3, vitamin B6 hydrochloride and vitamin B12, vitamin D, vitamin E acetate, vitamin K, and derivatives or mixtures thereof. Mention may be made among minerals such as, but not limited to, calcium, zinc, iron, magnesium, manganese, copper, iodine, fluoride, selenium, and mixtures thereof. Synthetic vitamins and minerals are also contemplated within the scope of compositions of the present disclosure. The addition of optional vitamins and minerals should be done with such care that the sensory characteristics of the beverage composition of the disclosure may not be significantly diminished. The at least one supplemental vitamin and/or mineral may be also added to assist a consumer in meeting the U.S. Recommended Daily Intake (RDI) for vitamins and minerals.

### Antioxidants

Beverage compositions of the present disclosure may further comprise at least one antioxidant. The at least one antioxidant may include, but is not limited to, ascorbic acid, vitamin E, propylgalate, sulfite and metabisulfite salts, thiodiproprionic acid and esters thereof, spice extracts, grape seed, tea extracts, and mixtures thereof.

### Carbohydrates

Beverage compositions of the present disclosure may further comprise carbohydrates. Mention may be made among dietary fiber, such as inulin.

### Lipids

Beverage compositions of the present disclosure may also further comprise lipids. Such lipids may include, but are not limited to, fatty acids, such as monounsaturated fatty acids, polyunsaturated fatty acids, Omega-3 fatty acids, and conjugated linoleic acid.

### Functional Additives

Functional additives include at least one additive that may provide health benefits beyond basic nutrition. For example, mention may be made among, but not limited to, phenols (such as afeic acid and ferulic acid), polyols, phytonutrients, and mixtures thereof. Phytonutrients include plant-derived compounds that may promote health or provide health benefits. Mention may be made of phytonutrients such as, but not limited to, phenolic acids (e.g., gallic acid, vannilic acid, p-coumaric acid, caffeic acid, chlorogenic acid, curcumin), flavonoids (e.g., flavones, such as apigenin, chrysin, luteolin, polymethoxylated flavones; flavonols, such as quercetin, kaempferol, myricetin; flavanones, such as hesperitin, naringenin; flavanols or catechins, such as catechin, epicatechin, epigallocatechin, epicatechin gallate, epigallocatechin gallate; anthocyanidins, such as cyanidin, pelargonin, peonidin, malvidin; isoflavones or phytoestrogens, such as genistein, diadzein, glycitein, lignans), stilbenes (e.g., resveratrol), coumarins (e.g., furanocoumarin), tannins (e.g., gallotannins, ellagitannins, condensed tannins, proanthocyanidins), carotenoids (e.g., beta-cryptoxanathin, lutein, zeaxanthin, alpha-carotene, beta-carotene, lycopene), alkaloids (e.g., caffeine, theobromine, theophylline, betaines), nitrogen-containing compounds (e.g., kynurenic acid, muscarine), organosulfur compounds (e.g., isothiocyanates, such as sulforaphane, indoles, alliin), phytosterols (e.g., beta-sitosterol, campersterol, stigmasterol), terpenes (precursors of carotenoids, limonoids, and steroids), plant stanols, and/or mixtures thereof.

### Optional Ingredients

Beverage compositions of the present disclosure may further comprise optional ingredients commonly found in conventional beverages. Such optional ingredients may be dispersed, solubilized, or otherwise mixed into or with the beverage composition of the present disclosure. The optional ingredients may be chosen from, but are not limited to, sweeteners, preservatives, ethylenediaminetetraacetic acid (EDTA), coloring agents, flavoring agents, emulsifiers, thickeners, i.e., viscosity modifiers and bodying agents, carbonation components, anti-foaming agents, texturizers, and mixtures thereof.

### Sweeteners

The beverage composition of the present disclosure may comprise at least one sweetener. The at least one sweetener may be chosen from nutritive sweeteners, non-nutritive sweeteners, and mixtures thereof. The at least one sweetener may be natural, artificial, or a mixture thereof. Of the nutritive (i.e., caloric) sweeteners, the present beverage compositions may include, for example, carbohydrate sweeteners such as monosaccharides and/or disaccharides. Mention may be made among caloric sweeteners including, but not limited to, fructose, sucrose, glucose, sugar alcohols, corn syrup, evaporated cane juice, rice syrups, maple syrup, black malt syrups, fruit juice concentrate, honey, agave, tapioca syrup, chicory root syrup, and mixtures thereof. The non-nutritive sweeteners may include, but are not limited to, luo han guo, stevia and derivatives thereof, erythrithol, acesulfame potassium, aspartame, neotame, saccharin, sucralose, tagatose, alitame, cyclamate, and mixtures thereof. Blends of nutritive as well as non-nutritive sweeteners are contemplated herein. The at least one sweetener may be present in an amount conventionally used in beverage compositions and may be adjusted depending upon the desired beverage composition.

### Preservatives

The beverage composition of the present disclosure may further comprise at least one preservative. As used herein, the term “preservative” includes all preservatives approved for use in beverage and/or food product compositions. Mention may be made among preservatives such as, but not limited to, chemical preservatives (e.g., citrates and salts thereof), esters and derivatives thereof, peptides, lauric arginate, neem oil, eugenol, p-cymene, thymol, carvacrol, linalool, natamycin, tea tree oil, fingerroot extract, acia powder, 4-hydroxybenzyl isothiocyanate and/or white mustard seed essential oil, ferulic acid, and mixtures thereof. Preservatives, moreover, may include, but are not limited to, lacto-antimicrobials such as lactoferrin, lactoperoxidase, lactoglobulins and lactolipids, ovo-antimicrobials such as lysozyme, ovotransferrin, ovoglobulin IgY and avidin, phyto-antimicrobials such as phyto-phenols, flavonoids, thiosulfinates, catechines, glucosinolates and agar, probiotics, nisin, pediocin, reuterin and sakacins, acid-antimicrobials such as lactic acid, acetic acid and citric acid, milieu-antimicrobials such as sodium chloride, polyphosphates, chloro-cides and ozone. The preservative may be present in an amount not exceeding maximum mandated levels, as established by the U.S. Food and Drug Administration or other food and beverage governing bodies.

### EDTA

The beverage composition may also comprise ethylenediaminetetraacetic acid (EDTA). As used herein, “EDTA” refers to natural and synthetically prepared EDTA and salts thereof such as calcium disodium ethylenediaminetetraacetic acid or ethylenediaminetetraacetic acid disodium salt. EDTA is a chelating agent that has been recognized by the FDA as being generally recognized as safe (GRAS) and can be used as a food additive. See 21 C.F.R. §§172.0135, 173.315. Because of its chemical structure, EDTA can, among other things, sequester metals and stabilize vitamins. It is postulated that by sequestering metals, EDTA removes these metals that are needed by enzymes of microorganisms and essentially starve the microorganisms, thereby assisting in preservation of the beverage composition.

### Coloring Agents

The beverage compositions of the present disclosure may further comprise at least one coloring agent. Mention may be made among colorants including, but not limited to, FD&C dyes, FD&C lakes, and mixtures thereof. Any other suitable colorant for use in beverages and/or food products may be used. For example, a mixture of FD&C dyes or a FD&C lake dye in combination with other conventional beverage and/or food colorants may be used. Moreover, other natural coloring agents may be utilized including, for example, fruit, vegetable, and/or plant extracts such as grape, black currant, carrot, beetroot, red cabbage, and hibiscus.

### Flavoring Agents

The beverage compositions of the present disclosure may further comprise at least one flavoring agent. The at least one flavoring agent may include, but is not limited to, oils, extracts, oleoresins, any other flavoring agent known in the art, and mixtures thereof. For example, suitable flavors include but are not limited to fruit flavors, cola flavors, coffee flavors, chocolate flavors, dairy flavors, coffee, kola nut, ginseng, cacao pod, and mixtures thereof. Suitable oils and extracts may include, but are not limited to, vanilla extract, citrus oil and extract, and mixtures thereof. These flavors may be derived from natural sources such as juices, essential oils and extracts, or may be synthetically prepared. Moreover, the at least one flavoring agent may be a blend of various flavors such as fruits and/or vegetables.

### Emulsifiers

The beverage compositions of the present disclosure optionally comprise at least one emulsifier. Any beverage and/or food grade emulsifier can be used. Mention may be of emulsifiers such as, but not limited to, gum acacia, modified food starches (e.g., alkenylsuccinate modified food starches), anionic polymers derived from cellulose (e.g., carboxymethylcellulose), gum ghatti, modified gum ghatti, xanthan gum, glycerol ester of wood rosin (ester gum), tragacanth gum, guar gum, locust bean gum, lecithin and mixtures thereof. Such emulsifiers are not used to facilitate combination of one or more neutralized juice bases with one or more beverage components in the beverage compositions of the disclosure, to stabilize the combined juice bases and beverage components, nor to stabilize individual beverage components. However, such emulsifiers can be optionally used, for example, to texturize the beverage compositions or to emulsify non-protein components of the beverage compositions. For example, a beverage composition can comprise a cloud emulsion or a flavor emulsion.

For cloud emulsions, the clouding agent can comprise at least one fat or oil stabilized as an oil-in-water emulsion using a suitable food grade emulsifier. Any of a variety of fats or oils may be employed as the clouding agent, provided that the fat or oil is suitable for use in compositions such as beverages. Any suitable beverage and/or food grade emulsifier can be used that can stabilize the fat or oil clouding agent as an oil-in-water emulsion.

Flavor emulsions useful in the beverage compositions of the present disclosure comprise at least one suitable flavor oil, extract, oleoresin, essential oil and the like, known in the art for use as flavorants in beverages.

### Thickeners

Beverage compositions of the present disclosure may optionally comprise at least one thickener. Mention may be made, among thickeners, i.e., viscosity modifiers and/or bodying agents, such as, but not limited to, cellulose compounds, gum ghafti, modified gum ghatti, guar gum, tragacanth gum, gum arabic, pectin, xanthum gum, carrageenan, locust bean gum, dried citrus pulp, and mixtures thereof.

### Carbonation

Carbonation (e.g., carbon dioxide) may be further added to the beverage compositions of the present disclosure based on techniques commonly known to a person of ordinary skill in the art. For example, carbon dioxide may be added to any water introduced into the beverage composition. Carbon dioxide may also be added directly to the juice base, the beverage component, or the beverage composition. The amount of carbonation introduced into the beverage compositions of the present disclosure will depend on the nature of the beverage composition and the desired level of carbonation.

### Anti-Foaming Agents

The beverage compositions of the present disclosure may further comprise at least one anti-foaming agent. The at least one anti-foaming agent may include, but is not limited to, calcium alginate, silicone polymers such as polydimethylsiloxane, and fatty acid esters such as propylene glycol fatty acid esters, glycerin fatty acid esters and sorbitan fatty acid esters, and mixtures thereof.

The amounts of these above-mentioned optional components, which may be present in the beverage compositions according to the disclosure, are those conventionally used in beverage compositions. In addition, the amount of these additional components will depend upon the desired beverage compositions.

### Method of Preparation

The disclosure also relates to a method of making the beverage composition of the disclosure comprising: neutralizing at least one acidic juice with at least one alkaline additive to form at least one neutralized juice base having a pH ranging from about 5.0 to about 6.1; and combining the at least one neutralized juice base with at least one beverage component, wherein the beverage composition is a low-acid composition.

The neutralized juice base of the present disclosure is prepared by measuring the pH of at least one acidic juice and adding sufficient alkaline additive to neutralize the pH of the acidic juice, such that the pH of the juice base is between about 5.0 and about 6.1. The alkaline additive can be, for example, chosen for its sensory compatibility with the acidic juice. Different alkaline additives are compatible with different juices. Many alkaline additives are compatible with multiple different juices, and many juices are compatible with multiple different alkaline additives. For the acidic juice and alkaline additives to be compatible, the resulting neutralized juice base should have acceptable organoleptic or sensory characteristics. Such sensory characteristics may include color, taste, smell, mouth feel, consistency, sweetness, and tartness.

The neutralized juice base is then combined with at least one beverage component to produce a low-acid beverage composition. As discussed above, the pH of the juice base facilitates combination of the juice base with at least one beverage component, as both have similar pHs. In addition, the pH of the juice base minimizes changes to the sensory characteristics of the resulting beverage composition.

The at least one juice base is combined with the at least one beverage component in an amount equivalent to about 20% to about 80% of the total volume of the beverage composition when using a single strength juice base. The at least one beverage component may be combined with the at least one juice base in an amount equivalent to about 80% to about 20% of the total volume of the beverage composition when using a single strength beverage component. If either the neutralized juice base or beverage component are concentrated components, the amounts of the neutralized juice base or beverage component are adjusted to produce beverage compositions having concentrations equivalent to the single strength concentrations discussed above.

Once at least one neutralized juice base has been combined with at least one beverage component, water may be optionally added as discussed above.

The beverage composition may be further combined with nutrient additives and/or optional ingredients as discussed above, depending on the composition.

The beverage composition may be further processed after the at least one neutralized juice base and the at least one beverage component have been combined. In one embodiment, the beverage composition may be pasteurized. In a further embodiment, the beverage composition may be partially sterilized at ultra high temperature (UHT). In still another embodiment of the disclosure, the beverage composition may optionally be homogenized. Such processing practices are known to persons skilled in the art.

### EXAMPLES

The following examples include embodiments of the beverage compositions comprising the present disclosure. In no way should these examples be interpreted as limitations upon the present disclosure.

### Example 1

Standard single strength orange juice from concentrate was prepared within specifications (11.8% Brix, 0.7% acid) by adding water to orange juice concentrate, and separated into four aliquots of 1437.89 grams. The first aliquot was used as a control, while the other three aliquots were adjusted with Ca(OH)₂ to different pHs. The control aliquot had a pH of 4.0, with the remaining aliquots adjusted to pH 5.0, 5.5, and 6.0 respectively. A previous experiment on orange juice having a final pH of 6.5 had been performed and sensory tested, but orange juice having this pH did not perform well in the sensory tests. In sensory tests, taste testers sampled various juice preparations for acceptable color, taste, smell, mouth feel, consistency, sweetness, and tartness.

Those treated juices of varying pH were mixed with reduced fat milk (2% butterfat) in a ratio of 30% milk to 70% juice by volume to determine coagulation and homogeneity levels for each pH. Sensory tests were performed on the results of that method. As a result of the sensory tests, beverage compositions having a pH of 6.0 were determined to be the most pleasing in the case of orange juice, though beverage compositions at pH 5.0 and 5.5 were also found to be acceptable.

### Example 2

Standard single strength white grape juice from concentrate was prepared within specifications (16.0% Brix, 0.236% acid) by adding water to white grape juice concentrate. The white grape juice was separated into two 8,050 gram aliquots. The Brix, acid, and pH were tested to ensure that the juice was within correct specifications. Twenty five grams of Ca(OH)₂ was weighed into a weigh boat. The first aliquot of juice was used as a control, while a pH probe was placed into the second container to monitor the change in pH as calcium hydroxide was added. Calcium hydroxide was slowly added into the second container until the mixture reached a pH of 6.0. The remaining calcium hydroxide was weighed to find the amount of alkaline used by difference, which was 8.74 grams.

That method was used to determine an optimal alkaline additive for raising the pH of different juices. For example, standard orange and apple juices from concentrate (apple juice specifications: 11.6% Brix, 0.464% acid, orange juice specifications as indicated above) were treated in a very similar manner, with the pH of the orange juice adjusted to 6.0, and the pH of the apple juice adjusted to 6.0. During experimentation, the calcium hydroxide-neutralized apple juice was found to coagulate with the added milk, and during subsequent heat processing, the coagulation was intensified. That coagulation was overcome by using KOH in place of Ca(OH)₂, as an alkaline additive in the apple juice base. The use of Ca(OH)₂ resulted in a pleasing beverage in both the orange juice and grape juice bases and so was deemed optimal for use in those applications.

### Example 3

Standard white grape juice was prepared according to specifications indicated above. The pH of the juice was adjusted to 6.0 with Ca(OH)₂ to produce a juice base. This juice base was blended with different ratios of reduced fat milk (2% butterfat) into 100 milliliter samples, with incremental percentages of juice base per sample ranging from 20% to 80%. The samples were tested for sensory agreeability to determine the optimal juice base-to-milk ratio.

The above treatment was repeated using 4% butterfat milk, 2% butterfat milk, lactose-free 2% butterfat milk, and calcium enriched organic soymilk. The above method was also repeated using orange and apple juice bases, testing the varying juice base-to-milk ratios as well as the different milk products.

The juice base-to-milk ratios presented in Table 1 resulted in beverage compositions with optimal sensory characteristics as determined in sensory tests.

TABLE 1
Beverage Composition Ratios

| | | | | | | | | % Juice | |
|---|---|---|---|---|---|---|---|---|---|
| | | | | | | | | Base | |
| | | | | | % | | | with | |
| | | | | | Alkali | % Juice | % Juice | Lactose | % Juice |
| | | | | | to | Base with | Base with | Free Milk | Base |
| | Initial | | % | Alkaline | Reach | Milk (2% | Milk (4% | (2% | with |
| Juice | pH | Brix | Acid | Additive | pH 6.0 | butterfat) | butterfat) | butterfat) | Soymilk |
| White | 3.37 | 16.11 | 0.20 | Ca(OH)₂ | 0.085 | 40% | 40% | 30% | 40% |
| grape | | | | | | | | | |
| Orange | 4.04 | 11.90 | 0.70 | Ca(OH)₂ | 0.35 | 30% | 30% | — | 30% |
| Apple | 3.80 | 11.70 | 0.47 | KOH | 0.36 | 50% | 50% | 40% | 50% |

From Table 1, the percentage of juice base used in beverage compositions prepared with lactose-free milk was lower than that of other preparations. That can be explained in part due to the fact that lactose-free milk was slightly sweeter than soymilk or regular milk. Accordingly, a smaller amount of juice in those preparations was more pleasing in sensory tests. Lactose-free milk mixed with orange juice was not found to be an agreeable blend in the sensory tests.

### Example 4

The above beverage compositions from Examples 1 to 3 were processed at 97.2° C. (207° F.) for 22 seconds and filled into sanitized 500 mL PET bottles at ≦4.4° C. (40° F.). During processing, the beverage output was visually examined to determine whether coagulation had occurred. Sensory tests were performed after processing to determine the effect upon the beverage. It was found that the sweetness of the beverage compositions was somewhat muted during the heat process. The beverages were also examined for complete homogenization following the procedure and found to be homogenous.

### Example 5

To examine storage stability of the beverage compositions of the disclosure, the following beverage compositions were stored at refrigerated temperatures (4° C.):

TABLE 2
Beverage Compositions Tested for Storage Stability

| | pH of | Percentage | Percentage | |
|---|---|---|---|---|
| | Juice | Volume of | Volume of 2% | Storage |
| Juice Base | Base | Juice Base | Butterfat Milk | Period |
| White grape juice + | 6.0 | 40% | 60% | 9.5 weeks |
| Ca(OH)₂ | | | | |
| Orange Juice + Ca(OH)₂ | 6.0 | 30% | 70% | 8 weeks |
| Apple juice + KOH | 6.0 | 50% | 50% | 6 weeks |

As those beverage compositions were not homogenized before pasteurization, a very slight separation (4-5 mm) was observed at the top of the white grape juice-milk and apple juice-milk products at the end of the storage period. Also, a very slight orange-colored sediment was observed at the bottom of the orange juice-milk products. All of those separations disappeared with a slight mixing (inversion) of the products.

The orange juice base-milk beverage composition, stored for 8 weeks, was described by tasters as tasting like a sweetened milk beverage with a slight orange flavor. The apple juice base-milk beverage composition, stored for 6 weeks, was described as having a sweet milk flavor with the taste of apple juice. Some date fruit flavor was mentioned by one taster. The white grape juice base-milk beverage composition, stored for 9.5 weeks, was described as tasting like sweetened milk, but with some off flavors. Tasters did not detect the flavor of white grape juice. All tasters agreed that those beverages could be successfully used as bases for further beverages, with added flavors, colors, and nutrients.

### Example 6

Standard apple juice was prepared according to specifications indicated above with a total of approximately two gallons, or 7,935 grams. A total of 18.88 grams of potassium hydroxide (0.238% w/w) were added to the juice to create a juice base, and the pH was raised from 3.67 to 6.00. Three liters of this juice base were blended with 3 liters of 2% milk to produce a total of 6 liters of juice base-milk beverage. This beverage was UHT (ultra high temperature) processed at 137.8° C. (280° F.) with a 6 second hold time and bottled into two 0.946 liter (32 ounce) sanitized PET bottles at 1.7° C. (35° F.). The appearance of the texture was smooth. The product was found to be stable after 3 weeks in refrigerated storage.

### Example 7

Three liters of the apple juice base from Example 6 were blended with 3 liters of soy milk to produce a total of 6 liters of juice base-soy milk beverage. This beverage was UHT processed at 137.8° C. (280° F.) with a 6 second hold time and bottled into two 0.946 liter (32 ounce) sanitized PET bottles at 1.7° C. (35° F.). The appearance of the texture was smooth. The product was found to be stable after 3 weeks in refrigerated storage.

### Example 8

Standard orange juice was prepared according to specifications indicated above, with a total of approximately two gallons, or 7,942 grams. A total of 30.84 grams of calcium hydroxide (0.388% w/w) were added to the juice to bring the pH from 3.78 to 6.00, and 1.8 liters of this juice base were blended with 4.2 liters of soy milk to produce a total of 6 liters of juice base-soy milk beverage. This beverage was UHT processed at 137.8° C. (280° F.) with a 6 second hold time and bottled into two 0.946 liter (32 ounce) sanitized PET bottles at 1.7° C. (35° F.). The appearance of the texture was smooth. The product was found to be stable after 3 weeks in refrigerated storage.

### Example 9

Standard white grape juice was prepared according to specifications indicated above, with a total of approximately two gallons, or 8,046 grams. A total of 7.66 grams of calcium hydroxide (0.0952% w/w) were added to the juice to bring the pH from 3.38 to 6.00, and 2.4 liters of this juice base were blended with 3.6 liters of soy milk to produce a total of 6 liters of juice base-soy milk beverage. This beverage was UHT processed at 137.8° C. (280° F.) with a 6 second hold time and bottled into two 0.946 liter (32 ounce) sanitized PET bottles at 1.7° C. (35° F.). The appearance of the texture was smooth. The product was found to be stable after 3 weeks in refrigerated storage.

### Example 10

Standard orange juice was prepared according to specifications indicated above, with a total of approximately 1.5 liters, or 1,573 grams. A total of 9.09 grams of potassium hydroxide (0.578% w/w) were added to the juice to bring the pH from 3.82 to 6.00, and 0.9 liters of this juice base were blended with 2.1 liters of 2% milk to produce a total of 3 liters of juice base-milk beverage. This beverage was UHT processed at 137.8° C. (280° F.) with a 6 second hold time and bottled into three 0.591 liter (20 ounce) sanitized PET bottles at 1.7° C. (35° F.). The appearance of the texture was smooth. The product was found to be stable after 3 weeks in refrigerated storage.

### Example 11

Standard white grape juice was prepared according to specifications indicated above, with a total of approximately 1 liter, or 1,063 grams. A total of 1.45 grams of potassium hydroxide (0.136% w/w) were added to the juice to bring the pH from 3.43 to 6.00. One liter of this juice base was blended with 1.5 liters of soy milk to produce a total of 2.5 liters of juice base-soy milk beverage. This beverage was UHT processed at 137.8° C. (280° F.) with a 6 second hold time and bottled into three 0.591 liter (20 ounce) sanitized PET bottles at 1.7° C. (35° F.). The appearance of the texture was smooth. The product was found to be stable after 3 weeks in refrigerated storage.

### Example 12

Additional beverage compositions of varying juice base-milk and/or soy milk blends were tested at varying pH. The beverage compositions are listed in Table 3. In general, standard orange juice, standard apple juice, and standard white grape juice were prepared according to specifications indicated in Table 3. V8 vegetable juice (Campbell's) and V8 Spicy Hot vegetable juice (Campbell's) were purchased. Each juice was mixed with an amount of potassium hydroxide to produce a juice base having a pH of either 5.0 or 5.5 as indicated in Table 3. The juice bases were mixed with either milk, soy milk, or both milk and soy milk to produce beverage compositions. Each beverage composition was UHT processed at 137.8° C. (280° F.) with a 6 second hold time and bottled in sanitized PET bottles at 1.7° C. (35° F.). For each beverage composition, the product texture appeared uniform and smooth by visual inspection.

TABLE 3
Additional Beverage Compositions

| | Juice and Juice Base Attributes | | | | | | | |
|---|---|---|---|---|---|---|---|---|
| | | | | Final | % (w/w) | Beverage Composition | | |
| | °Brix | % Acid | Initial | pH of | Alkali | Components (% v/v) | | |
| Beverage Composition | of | of | pH of | Juice | Added to | Juice | 2% | Soymilk |
| Description | Juice | Juice | Juice | Base | Juice | Base | Milk | (Silk ®) |
| Orange Juice and Milk | 11.8 | 0.70 | 3.80 | 5.0 | 0.40 | 30 | 70 | — |
| Orange Juice and Soy | 11.8 | 0.70 | 3.80 | 5.0 | 0.40 | 30 | — | 70 |
| Milk | | | | | | | | |
| Apple Juice and Milk | 11.5 | 0.46 | 3.74 | 5.5 | 0.20 | 50 | 50 | — |
| Apple Juice and Soy | 11.5 | 0.46 | 3.74 | 5.5 | 0.20 | 50 | — | 50 |
| Milk | | | | | | | | |
| White Grape Juice and | 16.0 | 0.20 | 3.48 | 5.5 | 0.14 | 40 | 60 | — |
| Milk | | | | | | | | |
| White Grape Juice and | 16.0 | 0.20 | 3.48 | 5.5 | 0.14 | 40 | — | 60 |
| Soy Milk | | | | | | | | |
| Orange Juice, Milk, and | 11.8 | 0.70 | 3.80 | 5.0 | 0.40 | 30 | 35 | 35 |
| Soy Milk | | | | | | | | |
| Apple Juice, Milk, and | 11.5 | 0.46 | 3.74 | 5.5 | 0.20 | 50 | 25 | 25 |
| Soy Milk | | | | | | | | |
| White Grape Juice, Milk, | 16.0 | 0.20 | 3.48 | 5.5 | 0.14 | 40 | 30 | 30 |
| and Soy Milk | | | | | | | | |
| V8 Vegetable Juice and | 5.0 | 0.40 | 4.21 | 5.5 | 0.21 | 60 | 40 | — |
| Milk | | | | | | | | |
| V8 Vegetable Juice and | 5.0 | 0.40 | 4.21 | 5.5 | 0.21 | 60 | — | 40 |
| Soy Milk | | | | | | | | |
| V8 Spicy Hot Vegetable | 5.0 | 0.40 | 4.15 | 5.5 | 0.21 | 55 | 45 | — |
| Juice and Milk | | | | | | | | |
| V8 Spicy Hot Vegetable | 5.0 | 0.40 | 4.15 | 5.5 | 0.21 | 55 | — | 45 |
| Juice and Soy Milk | | | | | | | | |

Other embodiments of the present disclosure will be apparent to those skilled in the art from consideration of the specification and practice of the disclosure herein. It is intended that the specification and examples be considered as exemplary only, with a true scope and spirit of the disclosure being indicated by the following claims.

What is claimed is:

1. A method of making a neutralized juice base having a pH ranging from about 5.0 to about 6.1 comprising combining at least one acidic juice with a sufficient amount of at least one alkaline additive to form the neutralized juice base.

2. The method according to claim 1, wherein the at least one alkaline additive is chosen from calcium hydroxide, potassium hydroxide, sodium hydroxide, magnesium hydroxide, potassium carbonate, sodium citrate, potassium bicarbonate, sodium bicarbonate, and mixtures thereof.

3. The method according to claim 1, wherein the at least one acidic juice chosen from a single strength juice and a juice concentrate.

4. The method according to claim 1, wherein the at least one acidic juice is chosen from at least one acidic fruit juice, at least one acidic vegetable juice, an acidic blend of vegetable juices, and acidic mixtures thereof.

5. A neutralized juice base having a pH ranging from about 5.0 to about 6.1 comprising:
a) at least one acidic juice; and
b) at least one alkaline additive.

6. The neutralized juice base according to claim 5, wherein the at least one alkaline additive is chosen from calcium hydroxide, potassium hydroxide, sodium hydroxide, magnesium hydroxide, potassium carbonate, sodium citrate, potassium bicarbonate, sodium bicarbonate, and mixtures thereof.

7. The neutralized juice base according to claim 5, wherein the acidic juice is chosen from a single strength juice and a juice concentrate.

8. The neutralized juice base according to claim 5, wherein the at least one acidic juice is chosen from at least one acidic fruit juice, at least one acidic vegetable juice, an acidic blend of vegetable juices, and acidic mixtures thereof.

9. A beverage composition comprising:
a) at least one neutralized juice base having a pH ranging from about 5.0 to about 6.1, comprising at least one acidic juice and at least one alkaline additive; and
b) at least one beverage component;
wherein the beverage composition is a stabilizer-free, low-acid composition.

10. The beverage composition according to claim 9, wherein the at least one beverage component is chosen from a single strength beverage component and a concentrated beverage component.

11. The beverage composition according to claim 9, wherein the at least one beverage component is chosen from dairy milk, soy milk, rice milk, coconut milk, botanical extracts, teas, coffees, protein drinks, protein emulsions, meal replacement drinks, sports drinks, energy drinks, soft drinks, carbonated drinks, frozen carbonated beverages, frozen uncarbonated beverages, functional drinks, health drinks, nectars, smoothies, shakes, tonics, horchata, syrups, cordials, dilutable drinks, and mixtures thereof.

12. The beverage composition according to claim 9, wherein the at least one beverage component is chosen from dairy milk, soy milk, and mixtures thereof.

13. The beverage composition according to claim 9, wherein the composition is chosen from a single strength composition and a concentrated composition.

14. The beverage composition according to claim 9, wherein the at least one neutralized juice base is present in an amount equivalent to about 20% to about 80% of a single strength juice base, by volume of the beverage composition.

15. The beverage composition according to claim 9, wherein the at least one beverage component is present in the composition in an amount equivalent to about 80% to about 20% of a single strength beverage component, by volume of the beverage composition.

16. The beverage composition according to claim 9, further comprising water.

17. The beverage composition according to claim 9, further comprising at least one nutrient additive chosen from proteins, amino acids, carnitine, taurine, ribose, inositol, vitamins, minerals, antioxidants, caffeine, carbohydrates, lipids, functional ingredients, and mixtures thereof.

18. The beverage composition according to claim 9, further comprising at least one optional ingredient chosen from sweeteners, preservatives, coloring agents, flavoring agents, thickeners, carbonation components, anti-foaming agents, texturizers, and mixtures thereof.

19. A beverage composition comprising:
a) white grape juice neutralized with an alkaline additive to form a neutralized white grape juice base having a pH ranging from about 5.0 to about 6.1;
b) a beverage component chosen from dairy milk, soy milk, and a mixture thereof; and
c) a flavor additive;
wherein the beverage composition is a stabilizer-free, low acid composition.

20. A method of making a beverage composition comprising:
a) neutralizing at least one acidic juice with at least one alkaline additive to form at least one neutralized juice base having a pH ranging from about 5.0 to about 6.1; and
b) combining the at least one neutralized juice base with at least one beverage component;
wherein the pH of the at least one beverage component, when combined with the at least one juice base, results in a low-acid beverage composition.

21. The method according to claim 20, wherein the at least one alkaline additive is chosen from calcium hydroxide, potassium hydroxide, sodium hydroxide, magnesium hydroxide, potassium carbonate, sodium citrate, potassium bicarbonate, sodium bicarbonate, and mixtures thereof.

22. The method according to claim 20, wherein the at least one acidic juice is chosen from a single strength juice and a juice concentrate.

23. The method according to claim 20, wherein the at least one acidic juice is chosen from at least one acidic fruit juice, at least one acidic vegetable juice, an acidic blend of vegetable juices, and acidic mixtures thereof.

24. The method according to claim 20, wherein the at least one beverage component is chosen from dairy milk, soy milk, rice milk, coconut milk, botanical extracts, teas, coffees, protein drinks, protein emulsions, meal replacement drinks, sports drinks, energy drinks, soft drinks, carbonated drinks, frozen carbonated beverages, frozen uncarbonated beverages, functional drinks, health drinks, nectars, smoothies, shakes, tonics, horchata, syrups, cordials, dilutable drinks, and mixtures thereof.

25. The method according to claim 20, wherein the at least one beverage component is chosen from dairy milk, soy milk, and mixtures thereof.

26. The method according to claim 20, wherein the at least one beverage component is chosen from a single strength beverage component and a concentrated beverage component.

27. The method according to claim 20, wherein the at least one neutralized juice base is present in an amount equivalent to about 20% to about 80% of a single strength juice base, by volume of the beverage composition.

28. The method according to claim 20, wherein the at least one beverage component is present in an amount equivalent to about 20% to about 80% of a single strength beverage component, by volume of the beverage composition.

29. The method according to claim 20, further comprising adding water to the beverage composition.

30. The method according to claim 20, further comprising adding at least one nutrient additive to the beverage composition, wherein the at least one nutrient additive is chosen from proteins, amino acids, carnitine, taurine, ribose, inositol, vitamins, minerals, antioxidants, caffeine, carbohydrates, lipids, functional ingredients, and mixtures thereof.

31. The method according to claim 20, further comprising adding at least one optional ingredient to the beverage composition, wherein the at least one optional ingredient is chosen from sweeteners, preservatives, coloring agents, flavoring agents, thickeners, carbonation components, anti-foaming agents, texturizers, and mixtures thereof.

32. The method according to claim 20, further comprising homogenizing the beverage composition after combining the at least one neutralized juice base with at least one beverage component.

33. The method according to claim 20, further comprising pasteurizing the beverage composition after combining the at least one neutralized juice base with at least one beverage component.

34. The method according to claim 20, further comprising UHT processing the beverage composition after combining the at least one neutralized juice base with at least one beverage component.
